(19) United States
(12) Patent Application Publication
(10) Pub. No.: US 2011/0233949 A1
(43) Pub. Date: Sep. 29, 2011

(54) GRIPPING TOOL

(75) Inventor: Fabrice PETIT, Orcevaux (FR)

(73) Assignee: GILLET GROUP, NOGENT (FR)

(21) Appl. No.: 12/887,148

(22) Filed: Sep. 21, 2010

Related U.S. Application Data
(60) Provisional application No. 61/330,565, filed on May 3, 2010.

(30) Foreign Application Priority Data
Sep. 24, 2009 (FR) 0904573

(51) Int. Cl. B25J 15/00

(52) U.S. Cl. 294/102.1

(57) ABSTRACT

The invention relates to a gripping tool, particularly for a mechanical part, comprising: a bell provided with gripping means facilitating the handling of said bell; a cage coaxial with said bell and rotatable, comprising at least one lateral opening and receiving said mechanical part; three bearing members including at least one movable retractable rotating roller; said bell being provided with at least one slope for varying the centre-to-centre distance between said retractable rotating roller and said bell based on the angular position of said retractable rotating roller, said cage and said retractable rotating roller being interconnected by guiding means arranged to guide said retractable rotating roller, said cage and said guiding means are arranged to enable the radial movement of said retractable rotating roller such that the axis thereof can pass through the wall of said cage.

### CROSS-REFERENCE TO RELATED APPLICATIONS

The present application claims priority to U.S. Provisional Patent Application Ser. No. 61/330,565, entitled “Outil de Prehension”, filed May 3, 2010 and to French Patent Application No. 09/04573, entitled “Outil de Prehension”, filed Sep. 24, 2009. Both of these applications are incorporated by reference herein in their entirety.

### FIELD OF THE INVENTION

The present invention relates to a tool for gripping mechanical parts, particularly a ball joint extractor, said gripping tool being intended for gripping mechanical parts, such as for example ball joint sockets, and facilitating the coupling and uncoupling thereof with other mechanical members.

### BACKGROUND OF THE INVENTION

Some cylindrical or spherical mechanical parts are particularly difficult to handle firmly with precision, particularly when coupling and uncoupling same with other mechanical members.

For example, this is the case of dowels, rod-shaped mechanical members having a threaded portion and a smooth portion, some uses whereof require gripping via the smooth portion. Due to the cylindrical form of the smooth portion, it is difficult to hold the dowel firmly without damaging the smooth surface thereof. Specific tools known as dowel extractors are commercially available which can be used to clamp the smooth and cylindrical portion of the dowel firmly while protecting same. A dowel extractor comprises a cylindrical hollow body provided for example on the outer surface thereof with a hexagonal form enabling the engagement of a wrench. The dowel extractor further comprises a hollow cylindrical sleeve housed in the hollow body. This sleeve is provided, in the wall thereof, with three slots having a V-shaped profile such that the most flared portion of each groove is oriented towards the outer surface of the sleeve and the least flared portion of each groove is oriented towards the sleeve axis. Each groove receives a ball, thus housed between the sleeve and the hollow body. The inner surface of the hollow body defines six slopes against which the balls travel. The centre-to-centre distance between the balls and the sleeve axis thus varies according to the position of the balls along the slopes. Each dowel extractor is dedicated for specific dowel diameters applied by the dimensions of the sleeve, hollow body, balls and the shape of the slopes. In addition, dowel extractors are frequently sold in kit form making it possible to offer a range of compatible diameters. These kits are of course more expensive than a single dowel extractor and a lot less easy to use. Furthermore, during use, there is a risk of losing either of the dowel extractors. Moreover, it is difficult to anticipate the diameters of future dowels to be extracted and thus select the correct kit. Therefore, there is a need for a dowel extractor compatible with varied dowel diameters over a wide range of values.

The problem is similar for ball and socket joints. A ball and socket joint is a joint consisting of a first spherical part, or ball joint, and a second part, or socket. The socket has a cylindrical outer shape and a spherical inner shape receiving the ball joint which can thus rotate and be oriented in all directions in relation to the socket. The ball joint is generally coupled with a ball joint rod and drag link. In practice, at least one of the directions of rotation of the ball and socket joint is limited by the presence of the ball joint rod and the steering rod. The ball and socket joint makes it possible, however, to achieve large angles of angulation between the ball joint rod and the steering rod.

Ball and socket joints are commonly used mechanical members, especially in the automobile industry, particularly fitted on motor vehicle steering. Arranged between the steering shaft and the vehicle wheels, ball and socket joints make it possible to induce pivoting of the vehicle wheels while enabling the rotation thereof and thus vehicle mobility. Manufacturers offer standardised ball and socket joints, the ball joint being already imbricated in the socket wherein it is locked in translation. To couple the ball and socket joint with other mechanical members, it is necessary to hold the ball and socket joint firmly to, for example, screw the steering rod onto a drive rod. This operation is rendered difficult by the high rotational mobility existing between the ball joint and the socket and by the cylindrical shape of the socket. A similar difficulty arises when decoupling the ball and socket joint, for example from the drive rod.

Specific tools known as “ball joint extractors” are commercially available, which enable the effective handling, by holding the handle of the ball joint extractor, of the cylindrical outer shape of the socket. An example of a known ball joint extractor is illustrated by FIGS. 1 to 3 wherein:

FIG. 1 is an axial sectional view, along the section line BB in FIG. 2, of the known ball joint extractor, said ball joint extractor containing a ball and socket joint represented in the form of an integral part,

FIG. 2 is a radial sectional view, along the section line AA in FIG. 1, of the ball joint extractor in FIG. 1, the ball joint extractor containing a ball and socket joint, and

FIG. 3 is an exploded perspective view of the ball joint extractor in FIG. 1.

With reference to these figures, the conventional ball joint extractor 100 comprises a tube 101 for receiving the ball joint rod 102 and enabling remote access to the ball and socket joints. Indeed, ball and socket joints are generally positioned under the vehicle radiator grille where, due to the presence of other mechanical members, little space is available to access the ball and socket joints. A first end of the tube 101 is provided with a hexagonal form 103 enabling the insertion of a wrench (not shown), for example a ratchet wrench. A second end of the tube 101 is provided with a bell 104 for receiving, extending from the ball joint rod 102, the socket 103 containing the ball joint (the ball joint is not differentiated from the socket 103 in FIGS. 1 to 3).

The ball joint extractor 100 also comprises a flange 105 housed in the bell 104 for receiving the ball and socket joint. The flange 105 is provided in two portions interconnected by three spacers 106 distributed at regular intervals on the periphery of the flange 105. The bell 104 is provided with a stop washer 107 and an elastic ring 108 coupled with a securing washer 109 preventing the lateral movement of the flange 105 in relation to the socket 104. Each portion of the flange 105 comprises three radial grooves 110 facing each other in pairs and wherein rotating rollers 111 are inserted. Each rotating roller 111 is thus rotatable about the axis thereof and radially translatable along the radial groove 110 in relation to the flange 105. The stroke of the rotating rollers 111 is limited, on the inside, by a continuous circular portion of the flange 105 imparting the flange 105 with the mechanical resistance thereof and, on the outside, by the inner face of the socket 104 against which the rotating rollers 111 travel. The inner surface of the socket 104 defines six slopes 112 against which the rotating rollers 111 travel. The six slopes 112 form three lobes defined by the peaks and troughs thereof. The centre-to-centre distance separating the rotating rollers 111 and the axis of the ball joint extractor 100 thus varies as a function of the position of the rotating rollers 111 along the slopes 112. The rotating rollers 111 are, moreover, stressed towards the axis of the ball joint extractor 100 by elastic rings 112 encompassing, on either side of the flange 105, the three axes of the rotating rollers 111.

The known ball joint extractor 100 may receive ball and socket joints of different diameters. Nevertheless, the maximum diameter suitable for gripping by the ball joint extractors is defined by the inner dimensions of the flange 105 receiving the ball and socket joint, in turn limited in terms of dimensions by the socket 104 wherein it is housed. It is standard for the range of compatible diameters to be between 35 and 40.5 mm. The design of the current ball joint extractor does not make it possible to accept larger diameters which poses problems for fitting and extracting ball and socket joints with larger diameters.

One solution consists of increasing the outer and inner dimensions of the socket 104 so that it can receive a flange 105 having larger dimensions. This solution is costly since it requires the production of a different new socket and thus additional production tools in relation to those already used for the standard socket. Due to the larger dimensions thereof, the new socket requires more raw material to be produced. Finally, the larger outer dimensions of said socket are relatively incompatible with the very restricted free space in the immediate vicinity of the ball and socket joints to be extracted. This solution is thus not satisfactory and the need remains for a ball joint extractor compatible with varied ball and socket joint diameters over a wide range of values.

Furthermore, in addition to the dimensional limitations involved, known ball joint extractors comprise a large number of parts, rendering the production thereof costly and the fitting thereof difficult. Moreover, in normal use thereof, they are subject to high mechanical stress, and the sturdiness thereof is not always satisfactory, particularly the rigidity of the angular positioning of the flanges in relation to each other.

As a general rule, there is a need for a gripping tool particularly for gripping cylindrical and spherical surfaces of different diameters, whether this gripping tool is a dowel extractor, a ball joint extractor, a pin extractor or any other similar gripping tool.

### SUMMARY OF THE INVENTION

The present invention is intended to remedy the drawbacks previously described by providing a gripping tool having limited outer dimensions, substantially similar to those of the corresponding current tools, suitable for receiving mechanical parts having varied dimensions to handle same firmly, said gripping tool being sturdy, easy to manufacture and having a moderate cost.

The invention relates to a gripping tool, particularly for a mechanical part, comprising at least:
a bell provided with gripping means facilitating the handling of the bell,
a cage coaxial with the bell and rotatable in the bell, the cage comprising at least one lateral opening passing through the wall of the cage, the cage defining a housing for receiving the mechanical part,
three bearing members including at least one retractable rotating roller, radially movable in relation to the lateral opening,
the inner face of the bell being provided with at least one slope arranged to vary the centre-to-centre distance between the retractable rotating roller and the bell based on the angular position of the retractable rotating roller in relation to the bell, the cage and the retractable rotating roller being interconnected by guiding means arranged to guide the retractable rotating roller radially during the variation of the centre-to-centre distance, characterised in that the cage and the guiding means are arranged to enable the radial movement of the retractable rotating roller such that the axis thereof can pass through the wall of the cage.

The minimum diameter of the mechanical part that can be held by the gripping tool is thus not limited by the cage dimensions. Furthermore, the gripping tool may also be suitable for significant variations of the diameters of the mechanical parts received.

The guiding means are arranged to enable the inclination of the retractable rotating roller in relation to the axis of the bell. This particular design enables the gripping tool to adapt to mechanical part geometries that are not perfectly cylindrical, for example conical parts or parts having a convex profile. Furthermore, the inclination of the retractable rotating roller enables improved absorption of some mechanical stress and thus renders the gripping tool sturdier. Finally, this inclination enables easier insertion of mechanical parts in the ball joint extractor.

The guiding means advantageously comprise at least one pivoting axis provided on the cage, and at least one pivoting arm connecting the pivoting axis to the retractable rotating roller. The gripping tool may also comprise two pivoting arms each connecting the pivoting axis to the retractable rotating roller, the pivoting arms being angularly movable with respect to each other in relation to the pivoting axis.

The cage is preferably provided with at least one abutment arranged to limit the pivoting of the pivoting arm towards the cage axis.

According to one preferred embodiment, the cage comprises two flanges interconnected by at least one rod, having a substantially parallel axis with that of the cage, and defining the pivoting axis at least partially. This design is particularly sturdy and enables the gripping tool to better absorb the mechanical stress to which it is subject during the use thereof.

The gripping tool advantageously comprises elastic means provided between the retractable rotating roller and the cage and arranged to actuate the movement of the axis of the retractable rotating roller towards the axis of the cage.

The elastic means comprise for example at least one torsional spring comprising turns, wherein at least a portion of the turns is borne by the pivoting axis, the torsional spring being provided with a first branch and a second branch extending on either side of the turns, one of the first and second branches defining the pivoting arm, the other pressing against the cage.

The torsional spring may comprise two portions of turns separated by an intermediate branch defining the second branch, the torsional spring comprising two first branches arranged on either side of the two turn portions.

Advantageously, the cage comprises three lateral openings separated in pairs by substantially equal angles, three retractable rotating rollers, each provided facing one of the lateral openings. The gripping tool thus provides isostatic gripping enabling the homogeneous distribution of the forces applied and thus increasing the sturdiness of the gripping tool.

The cage is preferably formed from a single integral part, rendering the gripping tool sturdier and less susceptible to torsional stress. The relative position of the flanges in relation to each other is thus stable over time.

The bell may be coupled with a tube, forming the gripping means at least partially, for receiving a portion of the mechanical part. This tube facilitates the handling of the gripping tool.

The retractable rotating roller advantageously consists of a plurality of cylinders wherein the axes may be inclined in relation to each other or suitable for inclination for improved engagement with mechanical parts having a convex profile or comprising two opposing slopes. This differentiated cylinder inclination also enables improved following of the profile of the mechanical part and thus easier insertion thereof.

In order to facilitate comprehension of the invention, the following description focuses non-exhaustively on a ball joint extractor. Obviously, the invention relates more generally to a gripping tool suitable for receiving mechanical parts having varied dimensions, said parts potentially having a cylindrical, square, hexagonal, oval outer shape, and an optionally rectilinear, for example convex, profile. It may for example consist of a dowel extractor, a pin extractor or any other similar tool.

### BRIEF DESCRIPTION OF THE DRAWINGS

The invention is described hereinafter, as a non-limitative example, with reference to the appended figures wherein:

FIG. 4 is an axial sectional view, along the section line CC in FIG. 5, of the ball joint extractor according to the invention, the ball joint extractor being represented with a ball and socket joint represented schematically in the form of an integral piece, the ball joint extractor particularly comprising an inner cage and a body;

FIG. 5 is a radial sectional view, along the section line DD in FIG. 4, of the ball joint extractor in FIG. 4 and a ball and socket joint;

FIG. 6 is an exploded perspective view of the ball joint extractor in FIG. 4;

FIG. 7 is an axial sectional view, along the section line CC in FIG. 5, of the body of the ball joint extractor in FIG. 1;

FIG. 8 is a perspective view of the inner cage of the ball joint extractor in FIG. 4, the cage being provided with rollers, securing pins and springs.

### DETAILED DESCRIPTION OF PREFERRED EMBODIMENTS

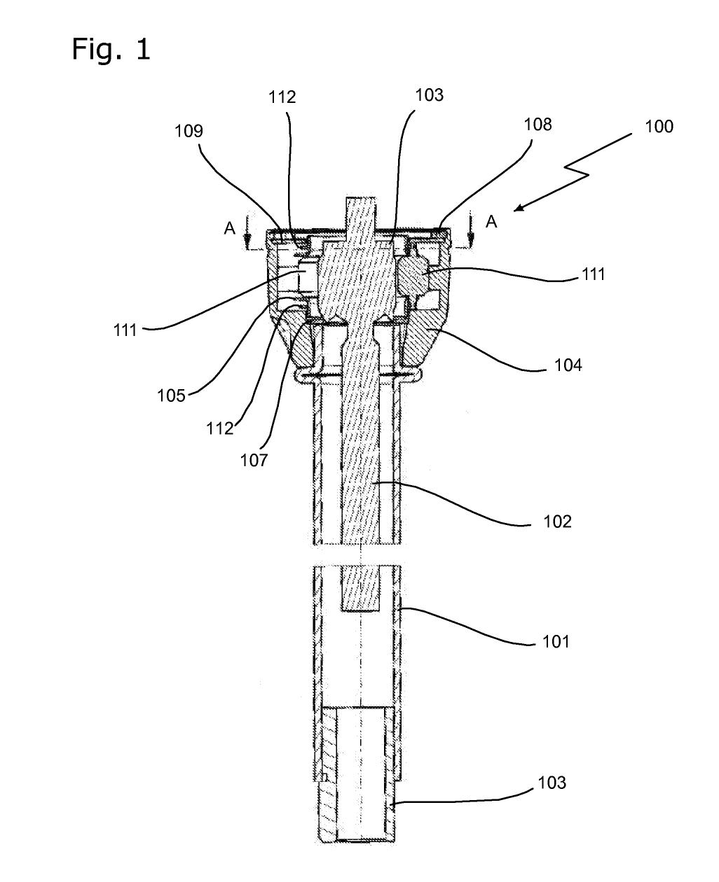

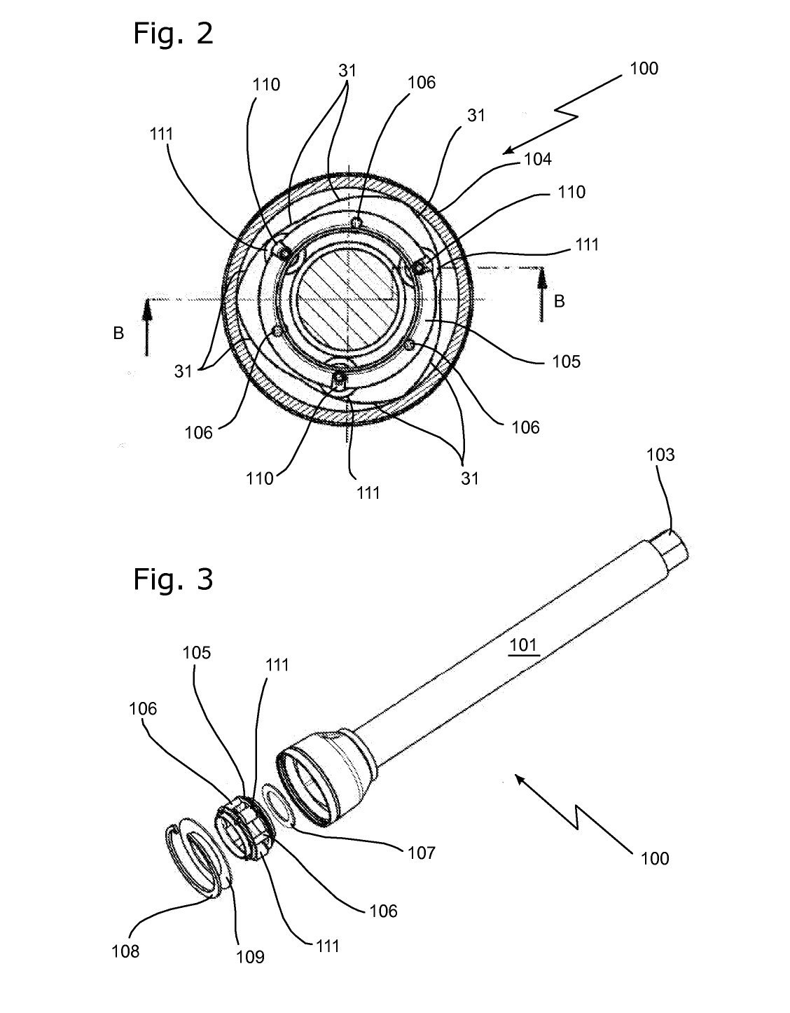

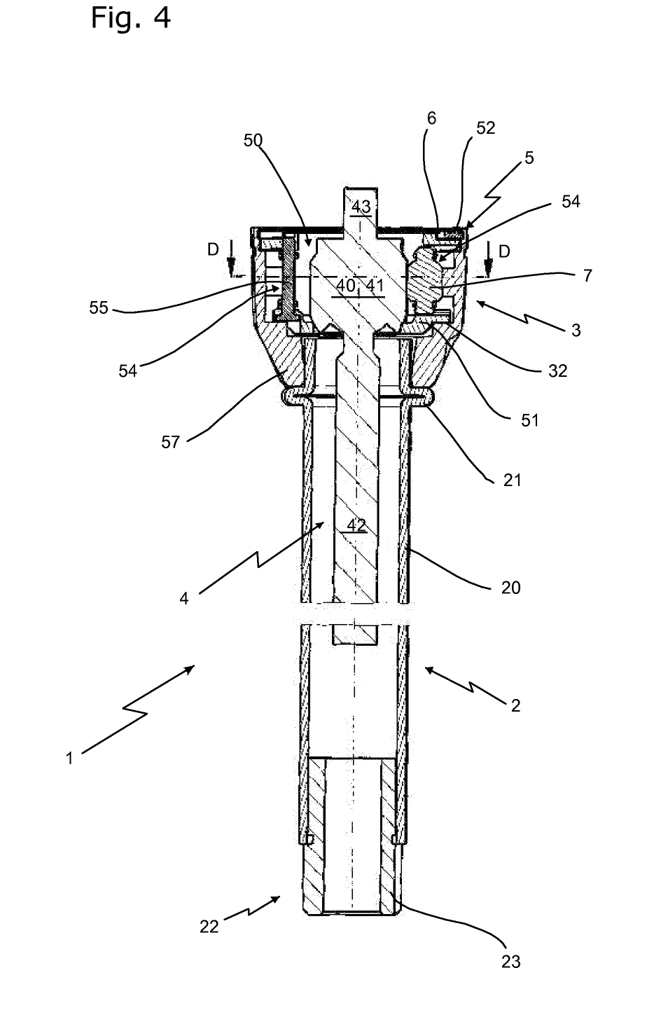

The gripping tool according to the invention is described with reference to a ball joint extractor illustrated by FIGS. 4 to 8. For clarification purposes, the ball and socket joint 4 is represented schematically in these figures by a hatched single block. In a known manner, the ball and socket joint 4 comprises a socket 40 containing the ball joint 41 coupled with a ball joint rod 42. The socket 40 in turn may be coupled with a steering rod 43.

With reference to FIG. 4, the ball joint extractor 1 according to the invention comprises a handle 2 coupled with a bell 3 receiving a cage 5.

The handle 2 comprises a tube 20 extending axially and wherein a first end is provided with an enlargement 21 for locking the bell 3 when fitted onto the tube 20. The second end of the tube 20 is coupled with a sleeve 22 housed in the tube 20 and provided at the free end thereof with a hexagonal form 23 for engaging a wrench (not shown), for example a ratchet wrench. As detailed hereinafter, the tube 20 may receive the ball joint rod 42 of a ball and socket joint 4 to be gripped by means of the ball joint extractor 1. The handle 2 is used for remote handling of the bell 3 and facilitates gripping of inaccessible ball joints.

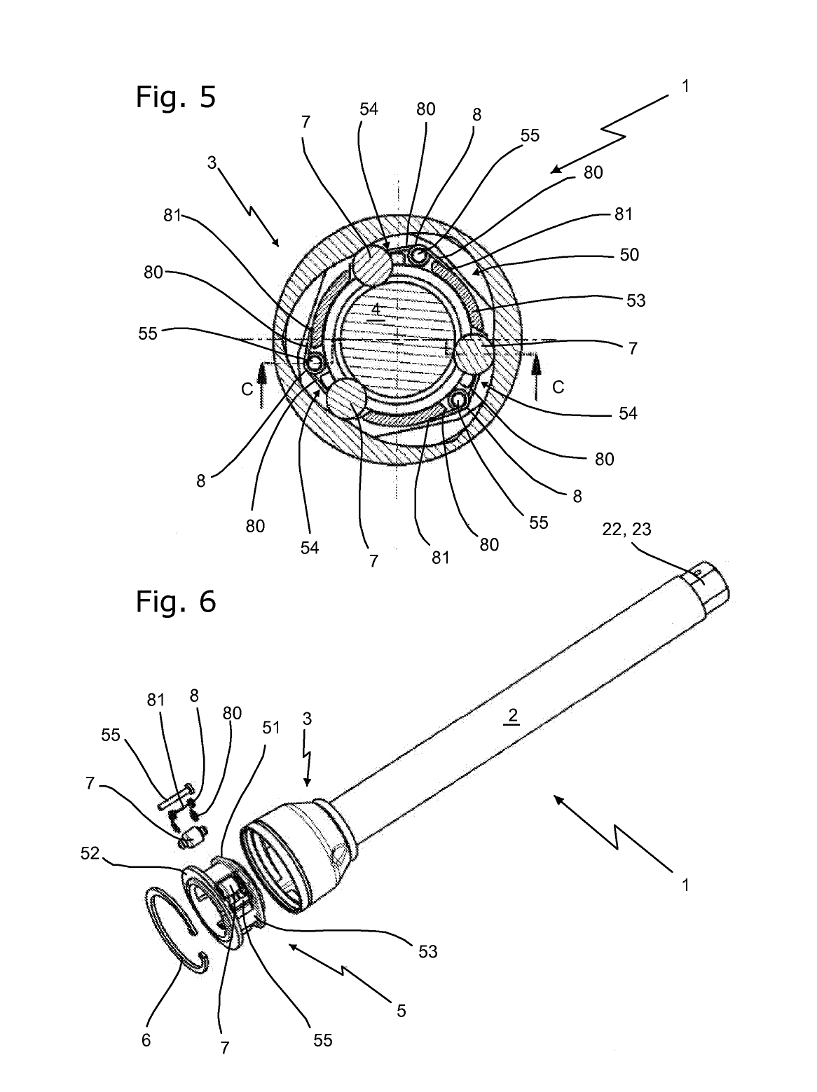

The bell 3 is arranged, extending from the handle 2 whereon it is fitted to abut against the enlargement 21. The bell 3 may be force-fitted onto the handle 2 and/or glued, welded or attached by any other suitable means. The bell 3 comprises coaxial holes having different diameters including, in particular, a main hole 30, represented in FIG. 7, for receiving the cage 5. This main hole 30 comprises, on either side of a cylindrical section, six curved slopes 31, forming a three-lobed shape provided with three peaks and three troughs. The function of the slopes 31 is detailed hereinafter.

The cage 5 is fitted coaxial in relation to the bell 3 wherein it is rotatably housed. The cage 5 defines a housing 50 for receiving the socket 40 of the ball and socket joint 4. The cage 5 comprises two flanges 51, 52 interconnected by a circular wall 53 traversed by lateral openings 54 having substantially similar shapes and dimensions and distributed at regular intervals on the circular wall 53. The flange 51 is provided with a return 57 for limiting the axial insertion of the ball and socket joint 4 in the ball joint extractor 1 by preventing the insertion of the socket 40 in the orifice defined by the return 57.

The flanges 51, 52 are also interconnected by three rods 55, having parallel axes with that of the cage 5, and each arranged facing one of the openings 54. Each of these rods 55 serves as a pivoting axis for a retractable rotating roller 7 provided facing an opening 54. For this purpose, the retractable rotating rollers 7 are individually connected to a rod 55 by the first branches 80 of a torsional spring 8 also comprising two turn portions interconnected by a radially offset intermediate branch 81 (or second branch) in relation to the turn portions. The turn portions are borne by the rod 55 and the intermediate branch 81 is resting against the circular wall 53. The first branches 80 of each torsional spring 8 thus form pivoting arms enabling the retractable rotating rollers 7 to pivot about the rods 55, via the lateral openings 55.

The retractable rotating rollers 7 are cylindrical and comprise a bearing surface enclosed by end fittings having smaller diameters, each of said smaller diameters being housed in one of the loops formed at the free ends of the first branches 80. Each retractable rotating roller 7 is thus pressed by the torsional spring 8 via the intermediate branch 81 on the cage 5, towards the axis of the cage 5 and the bell 3.

Furthermore, each retractable rotating roller 7 is rotatable about the axis thereof, locked in the loops of the torsional spring 8. The torsional spring 8 enables the individual and dissociated mobilisation of each of the first branches 80. The retractable rotating rollers 7 may thus be inclined in relation to the axis of the cage 5 and thus in relation to the axis of the bell 3. This inclination enables the ball joint extractor 1 to be able to grip mechanical parts having non-cylindrical shapes, for example conical, spherical mechanical parts or parts having an irregular circumference. Furthermore, this inclination facilitates the insertion of the mechanical parts into the ball joint extractor 1.

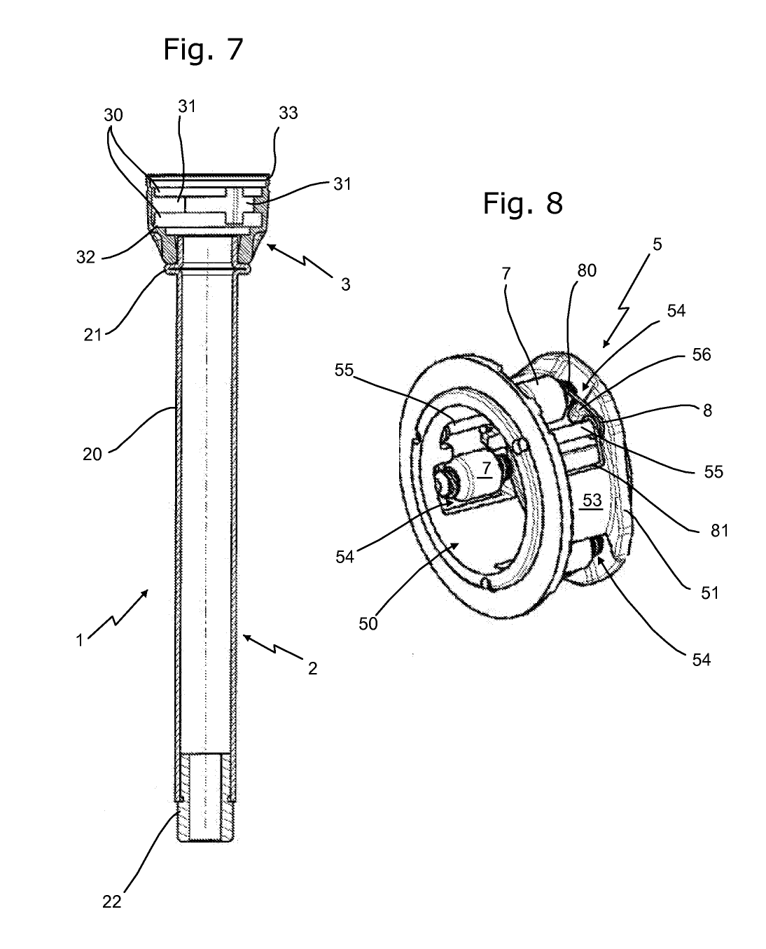

Opposite each lateral opening 54, the cage 5 is provided with two abutments 56 facing each other on each flange 51, 52. One of these abutments 56 is represented in FIG. 8. These abutments 56 limit the inward pivoting of the first branches 80 and thus the radial inward movement of the retractable rotating rollers 7.

During the clamping operation about the socket 40, radial outward separation of the retractable rotating rollers 7 is prevented by pressing the retractable rotating rollers 7 against the slopes 31. The angular movement of the cage 5 in relation to the bell 3 and pressing the retractable rotating rollers 7 on the slopes 31 varies the centre-to-centre distance between the retractable rotating rollers 7 and the cage 5. As described hereinafter, this offset extends until the retractable rotating rollers 7 are in a wedge configuration between the slopes 31 and the socket 40. The socket 40 is then held firmly by the ball joint extractor 1.

During this centre-to-centre distance variation, the retractable rotating rollers 7 can travel radially via the lateral openings 54. The radial inward movement of the retractable rotating rollers 7 is limited by the abutments 56 receiving the pressure from the first branches 80. The retractable rotating rollers 7 thus do not exceed a predefined minimum limit position limiting the force required for inserting the ball and socket joint 4.

The minimum gripping diameter, corresponding to the minimum mechanical part diameter that can be held by the ball joint extractor 1, is determined by the position of the retractable rotating rollers 7 when closest to the axis of the cage 5. When the cage 5 is provided with abutments 56, this position is determined by the abutments 56. The maximum gripping diameter, corresponding to the maximum mechanical part diameter that can be held by the ball joint extractor, is defined by the position of the retractable rotating rollers 7 when in the peaks of the lobes formed by the slopes 31. The range of mechanical part diameters that can be gripped by the ball joint extractor 1 according to the invention is thus broader than that of known ball joint extractors. With comparable outer dimensions, it is possible to move from a range limited between 35 and 40 mm to a range from at least 35 to 45 mm.

The cage 5 is locked in axial translation in the bell 3, by pressing the flange 51 thereof against a boss formed by the end of the main hole 30, via an elastic ring 6 housed in a circular groove 33 provided at the entry of the bell 3. The flanges 51, 52 and the circular wall 53 may be formed from a single integral part, for example, a moulded part.

In one alternative embodiment not shown, each rod is replaced by two studs facing each other on each of the flanges respectively. The torsional spring turn portions are fitted on each of the studs such that said turn portions engage with the studs to define the roller pivoting axis.

In a further alternative embodiment not shown, each retractable rotating roller is coupled with the rod two lateral rigid pivoting arms. Each of these pivoting arms is actuated by elastic return means tending to move each pivoting arm, radially inwards, and thus the corresponding retractable rotating roller in the same way. Each pivoting arm may thus be actuated by means of a torsional spring similar to those described above.

The return means may also comprise two elastic rings provided about the cage, positioned on either side of the retractable rotating rollers on the smallest diameters thereof, so as to jointly actuate the radial inward movement of the retractable rotating rollers. Finally, the return means may comprise leaf springs.

In a further alternative embodiment not shown, each retractable rotating roller consists of a plurality of aligned cylinders. To increase the adaptability of the ball joint extractor to mechanical parts having irregular or convex outer surfaces, said cylinders may be hinged in relation to each other. The cylinders may for example be borne by a flexible shaft actuated on either side of the two cylinders by two elastic pivoting arms. It is possible to envisage a third pivoting arm between the cylinders. The flexible shaft may also be coupled with rigid pivoting arms actuated by elastic return means. The cylinders may finally each be borne by an independent shaft, each shaft being individually coupled with pivoting arms. If the retractable rotating roller consists of two aligned cylinders borne by a single shaft, each retractable rotating roller may be actuated by a single pivoting arm wherein the end connecting the single shaft is arranged between the cylinders forming the retractable rotating roller.

In alternative embodiments not shown, the gripping tool may have the following different configurations:
one retractable rotating roller coupled with two fixed-axis (non-retractable) rotating rollers,
two retractable rotating rollers coupled with one fixed-axis (non-retractable) rotating roller,
one retractable rotating roller coupled with two fixed (non-rotating) abutments,
two retractable rotating rollers coupled with one fixed (non-rotating) abutment.

Thus having three bearing points, formed by the optionally retractable rotating rollers and fixed abutments makes it possible to obtain reliable and effective isostatic gripping of the mechanical part. The gripping tool may nonetheless comprise a greater number of bearing points.

A method for using the ball joint extractor 1 will be described hereinafter.

During the insertion step, the ball joint extractor 1 is held using the handle 2 so as to approach the bell 3 to the ball and socket joint 4 to be gripped, and insert said ball and socket joint 4 in the ball joint extractor 1. The insertion is limited by the socket 40 which rests against the return of the flange 51 of the cage 5. Once inserted, the ball joint rod 42 is received in the tube 20, the socket 40 is received in the bell 3 and in particular in the cage 5 between the retractable rotating rollers 7. During the insertion of the socket 40 into the bell 3, the inclined surface of the socket 40 comes into contact with the retractable rotating rollers 7, actuated radially inwards by the torsional springs 8, in turn pivoting about the rods 55. The elasticity of the first branches 80 enables the retractable rotating rollers 7 to be inclined in relation to the axis of the bell 3 and thus follow, to a certain extent, the profile of the socket 40 during the insertion thereof. Once the socket 40 has been inserted into the bell 3, the retractable rotating rollers 7 press on the outer surface of the socket 40, radially actuated inwards, by the torsional springs 8.

During the clamping step, the handle 2 of the ball joint extractor 1 is then rotated manually in the anticlockwise direction about the axis thereof, inducing the angular movement of the bell 3 and the slopes 31 and thus the travel of the retractable rotating rollers 7 on the outer surface of the mechanical part. This travel continues until the retractable rotating rollers 7 are wedged, towards the troughs of the lobes formed by the slopes 31, between the slopes 31 and the mechanical part to be gripped. As for known ball joint extractors, the slopes 31 and the diameters of the retractable rotating rollers 7 are selected to induce effective wedging of the retractable rotating rollers 7 on the mechanical part. The mechanical part is thus held firmly by the ball joint extractor 1. It can thus be handled easily, for example to unscrew the steering rod 42 of the ball and socket joint 4 of a drive rod (not shown).

It is clear from the description that the gripping tool 1 according to the invention is suitable, while having limited outer dimensions, for receiving mechanical parts having variable dimensions, over an extensive value range, greater than that allowed by known ball joint extractors and other gripping tools. The gripping tool 1 thus provides access to mechanical parts in congested environments. Furthermore, the gripping tool 1 comprises a limited number of parts, increasing the reliability and service life thereof.

Obviously, the examples described are merely specific illustrations in no way limiting the scope of the invention. Those skilled in the art may make modifications of the size, shape and material to the specific embodiment example without leaving the scope of the present invention. The scope of the present invention is therefore intended to be limited solely by the scope of the appended claims.

What is claimed is:

1. A gripping tool for a mechanical part comprising:
a bell provided with gripping means facilitating the handling of said bell;
a cage coaxial with said bell and rotatable in said bell, said cage comprising at least one lateral opening passing through the wall of said cage, said cage defining a housing for receiving said mechanical part;
three bearing members including at least one retractable rotating roller, radially movable in relation to said lateral opening;
the inner face of said bell being provided with at least one slope arranged to vary the centre-to-centre distance between said retractable rotating roller and said bell based on the angular position of said retractable rotating roller in relation to said bell, said cage and said retractable rotating roller being interconnected by guiding means arranged to guide said retractable rotating roller radially during the variation of the centre-to-centre distance, characterised in that said cage and said guiding means are arranged to enable the radial movement of said retractable rotating roller such that the axis thereof can pass through the wall of said cage.

2. A gripping tool according to claim 1, wherein said guiding means are arranged to enable the inclination of said retractable rotating roller in relation to the axis of said bell.

3. A gripping tool according to claim 1, wherein the guiding means comprise at least one pivoting axis provided on said cage, and at least one pivoting arm connecting the pivoting axis to said retractable rotating roller.

4. A gripping tool according to claim 3, further comprising two pivoting arms each connecting said pivoting axis to said retractable rotating roller, said pivoting arms being angularly movable with respect to each other in relation to the pivoting axis.

5. A gripping tool according to claim 3, wherein said cage is provided with at least one abutment arranged to limit the pivoting of said pivoting arm towards the axis of said cage.

6. A gripping tool according to claim 3, wherein said cage comprises two flanges interconnected by at least one rod, having a substantially parallel axis with that of said cage, and defining said pivoting axis at least partially.

7. A gripping tool according to claim 1, further comprising elastic means provided between said retractable rotating roller and said cage and arranged to actuate the movement of the axis of said retractable rotating roller towards the axis of said cage.

8. A gripping tool according to claim 7, wherein said elastic means comprise at least one torsional spring comprising turns, wherein at least a portion of the turns is borne by the pivoting axis, the torsional spring being provided with a first branch and a second branch extending on either side of said turns, one of said first and second branches defining the pivoting arm, the other pressing against said cage.

9. A gripping tool according to claim 8, wherein said torsional spring comprises two portions of turns separated by an intermediate branch defining said second branch, said torsional spring comprising two first branches arranged on either side of said two turn portions.

10. A gripping tool according to claim 1, wherein said cage comprises three lateral openings separated in pairs by substantially equal angles, three retractable rotating rollers, each provided facing one of the lateral openings.

11. A gripping tool according to claim 1, wherein said cage is formed from a single integral part.

12. A gripping tool according to claim 1, wherein said bell is coupled with a tube, forming the gripping means at least partially, for receiving a portion of said mechanical part.

13. A gripping tool according to claim 1, wherein said retractable rotating roller consists of a plurality of cylinders.

14. A gripping tool according to claim 3, further comprising elastic means provided between said retractable rotating roller and said cage and arranged to actuate the movement of the axis of said retractable rotating roller towards the axis of said cage.

15. A gripping tool according to claim 14, wherein said elastic means comprise at least one torsional spring comprising turns, wherein at least a portion of the turns is borne by the pivoting axis, the torsional spring being provided with a first branch and a second branch extending on either side of said turns, one of said first and second branches defining the pivoting arm, the other pressing against said cage.

16. A gripping tool according to claim 15, wherein said torsional spring comprises two portions of turns separated by an intermediate branch defining said second branch, said torsional spring comprising two first branches arranged on either side of said two turn portions.
